(19) United States
(12) Patent Application Publication
(10) Pub. No.: US 2017/0063544 A1
(43) Pub. Date: Mar. 2, 2017

(54) SYSTEM AND METHOD FOR SHARING DATA SECURELY

(71) Applicant: Rubicon Labs, Inc., San Francisco, CA (US)

(72) Inventors: William V. Oxford, Austin, TX (US); Stephen E. Smith, Austin, TX (US); Stuart W. Juengst, Austin, TX (US)

(21) Appl. No.: 15/247,676

(22) Filed: Aug. 25, 2016

Related U.S. Application Data
(60) Provisional application No. 62/210,027, filed on Aug. 26, 2015.

(51) Int. Cl. H04L 9/08; H04L 9/00; H04L 9/16; H04L 29/06; G06F 12/0813

(52) U.S. Cl. CPC H04L 9/0861; H04L 63/0435; H04L 63/06; G06F 12/0813; H04L 9/16; H04L 9/002; G06F 2212/1052; G06F 2212/154; G06F 2212/402; G06F 2212/60; G06F 2212/62

(57) ABSTRACT

Embodiments of systems and methods disclosed herein provide simple and effective methods for secure processes to share selected data with other processes and other memory locations, either secure or not, in a safe and secure manner. More specifically, in certain embodiments, systems and methods are disclosed that enable a secure data cache system to use one or more virtual machines to securely generate encryption keys based on information from multiple independent sources. In some embodiments, systems and methods are disclosed that provide protection from replay attacks by selectively changing the generated encryption keys.

### RELATED APPLICATIONS

This application claims a benefit of priority under 35 U.S.C. §119 to U.S. Provisional Patent Application No. 62/210,027, filed Aug. 26, 2015, entitled “System and Method for Sharing Data Securely,” by William V. Oxford et. al, which is hereby fully incorporated by reference in its entirety.

### TECHNICAL FIELD

This disclosure relates generally to security in computer systems. In particular, this disclosure relates to systems and methods by which a secure process can share selected data with other processes, either secure or not, in a nonetheless safe manner.

### BACKGROUND

In the systems described in commonly-assigned U.S. patent application Ser. No. 14/683,924, filed Apr. 10, 2015, entitled “System and Method for Sharing Data Securely,” and published as US 2015/0294123 A1, and U.S. patent application Ser. No. 14/683,988, filed Apr. 10, 2015, entitled “System and Method for an Efficient Authentication and Key Exchange Protocol,” and published as US 2015/0295713 A1, which are hereby incorporated by reference in their entirety as if fully set forth herein, systems are disclosed that provide simple and effective methods for authentication and key exchanges that are secure from man-in-the-middle attacks and are characterized by perfect forward secrecy and that enable a secure data cache system to write certain data to memory in plaintext form even after passing through a mandatory encryption process. Attempts may be made to compromise these types of systems, among others, by compromising licensing authorities or through the use of replay attacks. Thus, it is desirable to have methods by which secure processes may share selected data with other processes and other memory locations, either secure or not, in a safe and secure manner.

### SUMMARY

Embodiments of systems and methods disclosed herein provide simple and effective methods for secure processes to share selected data with other processes and other memory locations, either secure or not, in a safe and secure manner are disclosed.

In particular, in one embodiment, systems and methods are disclosed that enable a secure data cache system to use one or more virtual machines to securely generate encryption keys based on information from multiple independent sources. In some embodiments, systems and methods are disclosed that provide protection from replay attacks by selectively changing the generated encryption keys.

In other embodiments, systems and methods are disclosed that provide secure communications between a local device and a remote device by generating an encryption key based on information from two or more independent sources, such as third party licensing authorities, internal entropy sources, etc. In some embodiments, intermediate tokens are generated based on keys relating to multiple third parties, thus requiring cooperation with the multiple third parties, while prohibiting a single third party from generating valid keys.

In other embodiments, systems and methods are disclosed that provide secure communications between a local device and a remote device by providing replay attack protections by using an internal count register to selectively generate new encryption keys, as desired.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts one embodiment of an architecture for content distribution;

FIG. 2 depicts one embodiment of a target device;

FIG. 3 depicts one embodiment of a secure execution controller;

FIGS. 4A and 4B depict an embodiment of a cache architecture used for process working set isolation;

FIG. 5 depicts the generation in hardware of a nonce-based authCode/encryption key.

FIG. 6 depicts an exemplary secure processor data flow.

FIG. 7 depicts a secure software implementation.

FIG. 8 depicts a block diagram illustrating a basic principal of secure data cache eviction.

FIG. 9 depicts a block diagram illustrating an example where an encryption key is generated based on information from a CLA and an internal entropy source.

FIG. 10 depicts a block diagram illustrating an example where an encryption key is generated based on information from two independent CLAs.

FIG. 11 depicts a block diagram illustrating an example where an encryption key is generated based on information from two independent CLAs.

### DETAILED DESCRIPTION

The disclosure and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

A solution presented herein according to embodiments comes in two parts. The first part involves providing mechanisms to provide privacy of data while a processor is operating in secure mode. A second part involves providing mechanisms to provide replay attack protection.

As described in the publications referenced above, when data is written out to the processor's secure data cache while the processor is in secure mode, the data for that cache line is tagged as being secure. Subsequently, only the same secure process that actually wrote the data to that cache line in the first place can read that data without error.

However, when a secure process creates more data than can fit into the secure data cache (i.e., a data cache “overflow” condition), then a portion of the older data in the secure process' working set must be written (or “paged”) out to main memory to make room for the more recently-created data. Since main memory is a shared resource, then it is necessary to devise a system where this “paged out” data nonetheless remains accessible only to the secure process that created it in the first place. In cryptographic terms, a mechanism is needed that allows a secure process's working set to be paged out to shared memory in a manner that maintains both its security and its integrity.

The secure page-out process can be accomplished by encrypting the data as it is written out of data cache, using a standard (symmetric) encryption algorithm, such as AES-128 or AES-256. As per standard cryptographic practice, the security of the encrypted data should thus be entirely dependent on the security of the key for that encryption process. Ideally, only the secure process that “owns” that data should be able to recreate the encryption key correctly. In that case, no other process (either secure or not) would be able to access the unencrypted form of the data that is paged out to main memory. In addition, if an adversary attempts to modify the data when it is paged out, then the “owner” of that data should be able to detect such a modification before the data is loaded back into the secure working set memory space.

In some embodiments, the creation of a key for this encryption process can be accomplished by using a compound key mechanism (such as that described in commonly-assigned U.S. Pat. No. 7,203,844, issued Apr. 10, 2007, entitled “Method and System for a Recursive Security Protocol for Digital Copyright Control,” which is hereby incorporated by reference in its entirety as if fully set forth herein). By using this compound key method (where all of the “precursors” to the final compound key but one may be freely shared), a system is described where all of the information required to reconstruct an encryption key (the compound key) can be openly shared and yet, no external observer can correctly reconstruct the resulting compound (encryption) key. The one secret precursor is, of course, the device's secret key (which is architecturally invisible).

While there can be any number of other (public) precursors used to generate this compound encryption key, in one case there must be at least two precursors that may be used in its generation: the secure process' identity, and a process identifier. The secure process identity is a description of the operation that is to be accomplished, which may be as simple as a single label describing the operation, but may be more complex, for example, an executable binary image. The process identifier is a way of distinguishing between distinct secure operations (which may or may not be the same operation that is launched multiple times) and can be as simple as a nonce (a non-repeated random value) that is refreshed when the secure process is initially launched.

If these two elements (plus the device's secret key) are used as precursors to the compound encryption key, then this encryption key can be recreated at will using just the (public) precursors. Using this mechanism, a secure process can then safely page its secure data out to main memory. However, a service provider who is aware of the device's secret key, if compromised, can thus potentially compromise the security of the device. The mechanisms described below prevent a compromised service provider from compromising the security of the device, as well as providing a method for defending against replay attacks.

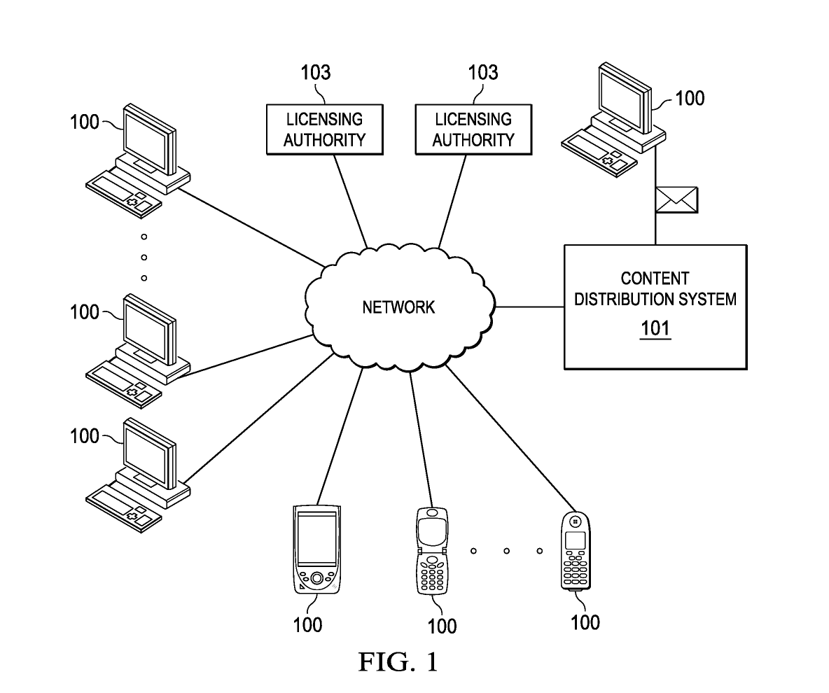

Before discussing embodiments in more detail, it may helpful to give a general overview of an example system in which embodiments of the present disclosure may be effectively utilized. FIG. 1 depicts one embodiment of such a system. Here, a content distribution system 101 may operate to distribute digital content (which may be for example, a bitstream comprising audio or video data, a software application, etc.) to one or more target units 100 (also referred to herein as target or endpoint devices) which comprise protocol engines. Examples other than the exemplary content distribution systems are also possible. These target units may be part of, for example, computing devices on a wireline or wireless network or a computer device which is not networked, such computing devices including, for example, a personal computers, cellular phones, personal data assistants, tablets, media players which may play content delivered as a bitstream over a network or on a computer readable storage media that may be delivered, for example, through the mail, etc. This digital content may compose or be distributed in such a manner such that control over the execution of the digital content may be controlled and security implemented with respect to distributed digital content or with respect to locally-generated data content.

In certain embodiments, control over the digital content may be exercised in conjunction with one or more licensing authorities 103. These licensing authorities 103, each of which may be referred to as a central licensing authority (CLA), though it will be understood that such a licensing authority need not be centralized and whose function may be distributed, or whose function may be accomplished by content distribution system 101, manual distribution of data on a hardware device such as a memory stick, etc. may provide a key and/or an authorization code. This key may be a compound key (or digital signature), that is both cryptographically dependent on the digital content distributed to the target device and bound to each target device (by means of a target devices secret or secrets). In one example, a target device may be attempting to execute a particular function in secure mode. This secure function (which may be, for example, a simple fixed function or an executable code block) may be used in order to access certain digital content.

Accordingly, to enable a given function to run in secure mode on a particular target device 100, at least one licensing authority 103 supplies a correct value of a compound key or digital signature (one example of which may be referred to as an Authorization Code) to the target device which is attempting to execute the function in secure mode. No other target device (e.g., TDn, where TDn≠TD1) can use the same compound key (or digital signature) to correctly authorize the secure function and no other compound key will correctly authorize that given secure function on that particular target device 100 (e.g., TD1).

As will be described in more detail below, when Target Device 100 (e.g., TD1) attempts to execute a given function in secure mode, the target device 100 (e.g., TD1) first evaluates a hash function (which may be hardware based) that creates a message digest (e.g., MD1) or digital signature of that secure function or executable code block, using the device's secret key (or keys) (e.g., SK1).

In fact, such a message digest (e.g., MD1) may be referred to as a Message Authentication Code (MAC) or a digital signature as well as a compound key, since the hash function result depends on the target device's secret key value (e.g., SK1) as well as the public input (e.g., the given function). Thus, the resulting value of the message digest (e.g., MD1) is cryptographically bound to both the secret key of the target device 100 and to the given function. If the licensing authority distributed compound key (e.g., DS1) matches the value of the message digest (e.g., MD1) it can be assured that the given function is the same one that is intended to be authorized (or, in the case of a secure executable, the candidate code block e.g., CC1) and that the function is both unaltered as well as authorized to run in secure mode on the intended target device 100 (e.g., TD1). The target device 100 can then execute the secure function (or the candidate code block) in secure mode safely.

As can be seen then, in one embodiment, when a given secure function is performed on a target device 100, the target device 100 may be executing code that has both been verified as unaltered from its original form, and is cryptographically “bound” to the target device 100 on which it is executing. Thus, there is no dependency on a secure root of trust that is external to (e.g., not an integral part of) the secure function itself. This method of ensuring secure execution of a given function on a particular target device may be contrasted with other systems, where a processor may automatically enter secure mode upon hardware reset and then may execute in a hypervisor mode or the like in order to establish a root-of-trust that must be shared with other (e.g., distinct) secure functions in some manner.

Accordingly, using embodiments as disclosed, any or all of these data such as the compound key from a licensing authority, the message digest, the candidate code block, etc. (e.g., DS1, MD1, CC1) may be completely public as longs as the secret key for the target device 100 (e.g., SK1) is not exposed. Thus, it is desired that the value of the secret key of a target device is never exposed, either directly or indirectly. Accordingly, as discussed above, embodiments of the systems and methods presented herein, may, in addition to protecting the secret key from direct exposure, protect against indirect exposure of the secret key on target devices 100 by securing the working sets of processes executing in secure mode on target devices 100.

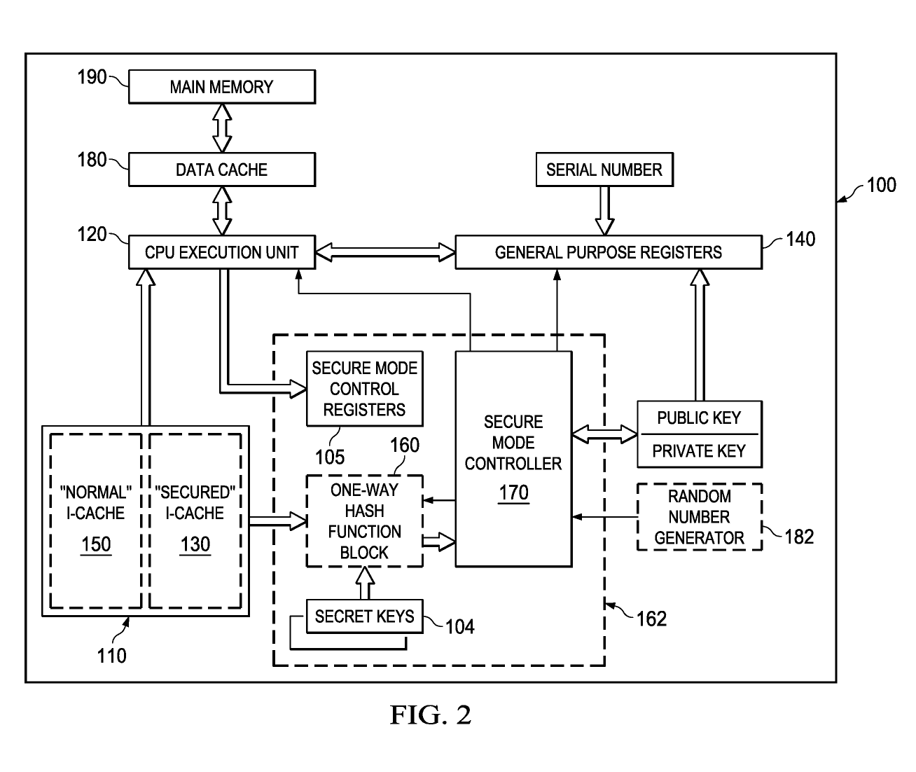

FIG. 2 shows the architecture of one embodiment of a target device that is capable of controlling the execution of a given secure function that may access some distributed digital content or implementing security protocols in conjunction with received digital content. Elements of the target unit may include a set of blocks, which allow a process to execute in a secured mode on the target device such that when a process is executing in secured mode the working set of the process may be isolated. It will be noted that while these blocks are described as hardware in this embodiment, secure software may be utilized to accomplish similar functionality with equal efficacy. It will also be noted that while certain embodiments may include all the blocks described herein other embodiments may utilize lesser or additional blocks.

The target device 100 may comprise a CPU execution unit 120 which may be a processor core with an execution unit and instruction pipeline. Target unit 100 may also contain a true random number generator 182 which may be configured to produce a sequence of sufficiently random numbers or which can then be used to supply seed values for a pseudo-random number generation system. This pseudo-random number generator can also potentially be implemented in hardware, software or in secure software.

One-way hash function block 160 may be operable for implementing a hashing function substantially in hardware. One-way hash function block 160 may be a part of a secure execution controller 162 that may be used to control the placement of the target device 100 in secure mode or that may be used to control memory accesses (e.g., when the target device 100 is executing in secured mode), as will be described in more detail herein at a later point.

In one embodiment, one way hash function block 160 may be implemented in a virtual fashion, by a secure process running on the same CPU that is used to evaluate whether a given process is secure or not. In certain embodiments two conditions may be adhered to, ensuring that such a system may resolve correctly. First, the secure mode “evaluation” operation (e.g., the hash function) proceeds independently of the execution of the secure process that it is evaluating. Second, a chain of nested evaluations may have a definitive termination point (which may be referred to as the root of the “chain of trust” or simply the “root of trust”). In such embodiments, this “root of trust” may be the minimum portion of the system that should be implemented in some non-changeable fashion (e.g., in hardware or in a state machine sequence description that is fixed by means of a ROM or some other means of storing a “firmware” description of the hardware function equivalent). This minimum feature may be referred to as a “hardware root of trust”.

Another portion of the target unit 100 may be a hardware-assisted secure mode controller block 170. This secure mode controller block 170 can be implemented in a number of ways. In one example, the secure mode controller block 170 is a general purpose processor or a state machine. The secure execution controller 162 also includes secure mode control registers 105, which define the configuration of the current security state on a process by process basis. As shown in FIG. 2, the secret key 104 and another number (for example, in initialization vector or nonce) are run through the one-way hash function block 160. The result of the hash function is repeatable and is a derivative of the secret. The result of the hash function is provided to the secure mode controller block 170.

It is not material to embodiments exactly which encryption algorithm is employed by this hardware block 170. In order to promote the maximum flexibility, it is assumed that the actual implementation details may be such that any encryption mechanism may be used in a non-algorithmically specific manner, and there are many different means by which this mechanism can be implemented all of which are contemplated herein. It should be noted at this point that the terms encryption and decryption will be utilized interchangeably herein when referring to engines (algorithms, hardware, software, etc.) for performing encryption/decryption. As will be realized if symmetric encryption is used in certain embodiments, the same or similar encryption or decryption engine may be utilized for both encryption and decryption. In the case of an asymmetric mechanism, the encryption and decryption functions may or may not be substantially similar, even though the encryption and decryption keys may be different.

Target device 100 may also comprise a data cache 180, the instruction cache 110 where code that is to be executed can be stored, and main memory 190. Data cache 180 may be almost any type of cache desired such as a L1 or L2 cache. In one embodiment, data cache 180 may be configured to associate a secure process descriptor with one or more pages of the cache and may have one or more security flags associated with (all or some subset of the) lines of a data cache 180. For example, a secure process descriptor may be associated with a page of data cache 180.

Generally, embodiments of target device 100 may isolate the working set of a process executing in secure mode stored in data cache 180 such that the data for one secure process (or function) is inaccessible to any other process, even after the original process terminates. More specifically, in one embodiment, the entire working set of a currently-executing process may be stored in data cache 180 and writes to main memory 190 and write-through of that cache (e.g., to main memory 190) disallowed (e.g., by secured execution controller 162) when executing in secured mode.

Additionally, for any of those lines of data cache 180 that are written to while executing in secure mode (e.g., a “dirty” cache line) those cache lines (or the page that comprises those cache lines) may be associated with a secure process descriptor for the currently executing process. The secure process descriptor may uniquely specify those associated “dirty” cache lines as belonging to the executing secure process, such that access to those cache lines can be restricted to only that process (e.g., be by secured execution controller 162).

In certain embodiments, in the event that the working set for a secure process overflows data cache 180 and portions of data cache 180 that include those dirty lines associated with the security descriptor of the currently executing process need to be written to main memory (e.g., a page swap or page out operation) external data transactions between the processor and the bus (e.g., an external memory bus) may be encrypted (e.g., using block 170 or encryption software executing in secure mode). The encryption (and decryption) of data written to main memory may be controlled by secure execution controller 162.

The key for such an encryption may be the secure process descriptor itself or some derivative thereof and that secure descriptor may itself be encrypted (e.g., using the target device's 100 secret key 104 or some derivative thereof) and stored in main memory 190 in encrypted form as a part of the data being written to main memory. Although it may seem counter-intuitive to store an encryption key in encrypted form that can only be correctly decrypted by an unencrypted form of itself, the correctly-decrypted version loaded in from main memory can be used as a simple integrity check on the memory storage archival process and on the decryption process itself.

Instruction cache 110 is typically known as an I-Cache. In some embodiments, a characteristic of portions of this I-Cache 110 is that the data contained within certain blocks be readable only by CPU execution unit 120. In other words, this particular block of I-Cache 130 is execute-only and may not be read from, nor written to, by any executing software. This block of I-Cache 130 will also be referred to as the “secured I-Cache” 130 herein. The manner by which code to be executed is stored in this secured I-Cache block 130 may be by way of another block which may or may not be depicted. Normal I-Cache 150 may be utilized to store code that is to be executed normally as is known in the art.

Additionally, in some embodiments, certain blocks may be used to accelerate the operation of a secure code block. Accordingly, a set of CPU registers 140 may be designated to only be accessible while the CPU 120 is executing secure code or which are cleared upon completion of execution of the secure code block (instructions in the secured I-cache block 130 executing in secured mode), or if, for some reason a jump to any section of code which is located in the non-secure or “normal” I-Cache 150 or other area occurs during the execution of code stored in the secured I-Cache 130.

In one embodiment, CPU execution unit 120 may be configured to track which registers 140 are read from or written to while executing the code stored in secured I-cache block 130 and then automatically clear or disable access to these registers upon exiting the “secured execution” mode. This allows the secured code to quickly “clean-up” after itself such that only data that is permitted to be shared between two kinds of code blocks is kept intact. Another possibility is that an author of code to be executed in the secured code block 130 can explicitly identify which registers 140 are to be cleared or disabled. In the case where a secure code block is interrupted and then resumed, then these disabled registers may potentially be re-enabled if it can be determined that the secure code that is being resumed has not been tampered with during the time that it was suspended.

In one embodiment, to deal with the “leaking” of data stored in registers 140 between secure and non-secure code segments a set of registers 140 which are to be used only when the CPU 120 is executing secured code may be identified. In one embodiment, this may be accomplished utilizing a version of the register renaming and scoreboarding mechanism, which is practiced in many contemporary CPU designs. In some embodiments, the execution of a code block in secured mode is treated as an atomic action (e.g., it is non-interruptible) which may make such renaming and scoreboarding easier to implement.

Even though there may seem to be little possibility of the CPU 120 executing a mixture of “secured” code block (code from the secured I-Cache 130) and “unsecured code” (code in another location such as normal I-cache 150 or another location in memory), such a situation may arise in the process of switching contexts such as when jumping into interrupt routines, or depending on where the CPU 120 context is stored (most CPU's store the context in main memory, where it is potentially subject to discovery and manipulation by an unsecured code block).

In order to help protect against this eventuality, in one embodiment, another method which may be utilized for protecting the results obtained during the execution of a secured code block that is interrupted mid-execution from being exposed to other execution threads within a system is to disable stack pushes while the target device 100 is operating in secured execution mode. This disabling of stack pushes will mean that a secured code block is thus not interruptible in the sense that, if the secured code block is interrupted prior to its normal completion, it cannot be resumed and therefore must be restarted from the beginning. It should be noted that in certain embodiments if the “secured execution” mode is disabled during a processor interrupt, then the secured code block may also potentially not be able to be restarted unless the entire calling chain is restarted.

Each target unit 100 may also have one or more secret keys 104; the values of which are not software-readable. In one embodiment, the first of these keys (the primary secret key) may be organized as a “seed” for a subsequently-derived set of secret keys, of which only one is readable at any particular time. Another embodiment may have multiple sets of secret keys, each set belonging to a separate secure “state” or “owner” of the device. If the “ownership” of a unit is changed (for example, the equipment containing the protocol engine is sold or its ownership is otherwise transferred), then the currently active primary secret key may be “cleared” or disabled or overwritten by a different value. This new value can either be transferred to the unit in a secure manner or it can be already stored in the unit in such a manner that it is only used when this first key is cleared. In effect, this is equivalent to issuing a new primary secret key to that particular unit when its ownership is changed or if there is some other reason for such a change (such as a compromised key). A secondary secret key may be utilized with the target unit 100 itself. Since the CPU 120 of the target unit 100 cannot ever access the values of either the primary or the secondary secret keys, in some sense, the target unit 100 does not even “know” its own secret keys 104. These keys are only stored and used within the security execution controller 162 of the target unit 100 as will be described.

In another embodiment, the two keys may be constructed as a list of “paired” keys, where one such key is implemented as a one-time-programmable register and the other key in the pair is implemented using a re-writeable register. In this embodiment, the re-writeable register may be initialized to a known value (e.g., zero) and the only option that may be available for the system to execute in secure mode in that state may be to write a value into the re-writeable portion of the register. Once the value in this re-writeable register is initialized with some value (e.g., one that may only be known by the Licensing Authority, for example), then the system may only then be able to execute more general purpose code while in secure mode. If this re-writeable value should be re-initialized for some reason, then the use of a new value each time this register is written may provide increased security in the face of potential replay attacks.

Yet another set of keys may operate as part of a temporary public/private key system (also known as an asymmetric key system or an asymmetric crypto system). The keys in this pair may be generated on the fly and may be used for establishing a secure communications link between similar units, without the intervention of a central server. As the security of such a system is typically lower than that of an equivalent key length symmetric key encryption system, these keys may be larger in size than those of the set of secret keys mentioned above. These keys may be used in conjunction with the value that is present in the on-chip timer block in order to guard against “replay attacks”, among other things. Since these keys may be generated on the fly, the manner by which they are generated may be dependent on the random number generation system 182 in order to increase the overall system security.

In one embodiment, one method that can be used to affect a change in “ownership” of a particular target unit is to always use the primary secret key as a compound key in conjunction with another key 107, which we will refer to as a timestamp or timestamp value, as the value of this key may be changed (in other words may have different values at different times), and may not necessarily reflect the current time of day. This timestamp value itself may or may not be itself architecturally visible (e.g., it may not necessarily be a secret key), but nonetheless it will not be able to be modified unless the target unit 100 is operating in secured execution mode. In such a case, the consistent use of the timestamp value as a component of a compound key whenever the primary secret is used can produce essentially the same effect as if the primary secret key had been switched to a separate value, thus effectively allowing a “change of ownership” of a particular target endpoint unit without having to modify the primary secret key itself.

As may be understood then, the target device 100 may use secure execution controller 162 and data cache 180 to isolate the working sets of processes executing in secure mode such that the data is inaccessible to any other process, even after the original process terminates. This working set isolation may be accomplished in certain embodiments by disabling off-chip writes and write-through of data cache when executing in secured mode, associating lines of the data cache written by the executing process with a secure descriptor (that may be uniquely associated with the executing process) and restricting access to those cache lines to only that process using the secure process descriptor. Such a secure process descriptor may be a compound key or a digital signature based on the device's secret key, such as an authorization code or some other derivative value thereof.

When it is desired to access data in the data cache by the process the secure descriptor associated with the currently executing process may be compared with the secure descriptor associated with the requested line of the secure data cache. If the secure descriptors match, the data of that cache line may be provided to the executing process while if the secure descriptors do not match the secure data may not be accessed and another action may be taken.

Moreover, in certain embodiments, in the event that the working set for a secure process overflows the on-chip cache, and portions of cache that include those dirty lines associated with the secure process descriptor need to be written to main memory (e.g., a page swap or page out operation) external data transactions between the processor and the bus (e.g., an external memory bus) may be encrypted. The key for such an encryption may be the secure process descriptor itself or some derivative thereof and that secure process descriptor may be encrypted (e.g., using the target device's secret key or some derivative thereof) prior to being written out to the main memory. Again, this encryption processes may be accomplished substantially using the hashing block of the target device or by use of an software encryption process running in secure mode on the processor itself or some other on-chip processing resource, or by use of a encryption function that is implemented in hardware. These embodiments may be better understood with reference to U.S. patent application Ser. No. 13/847,370, entitled “Method and System for Process Working Set Isolation”, by Oxford, which is hereby incorporated herein by reference in its entirety.

To enhance performance, in certain cases where a secure process may have a large working set or is frequently interrupted (e.g., entailing many page swaps) a subset of the processes working set that is considered “secure” may be created (e.g., only a subset of the dirty cache lines for the process may be associated with the secure descriptor) and only encrypt those cache lines or the portion of the cache containing those lines, when it is written out to external memory.

Additionally, to enhance performance, an off-chip storage mechanism (e.g., a page swapping module) can be run asynchronously in parallel with an interrupting process (e.g., using a DMA unit with integrated AES encryption hardware acceleration) and thus, could be designed to have a minimal impact on the main processor performance. In another embodiment, a separate secure “working set encapsulation” software module may be used to perform the encryption prior to allowing working set data to be written out to memory.

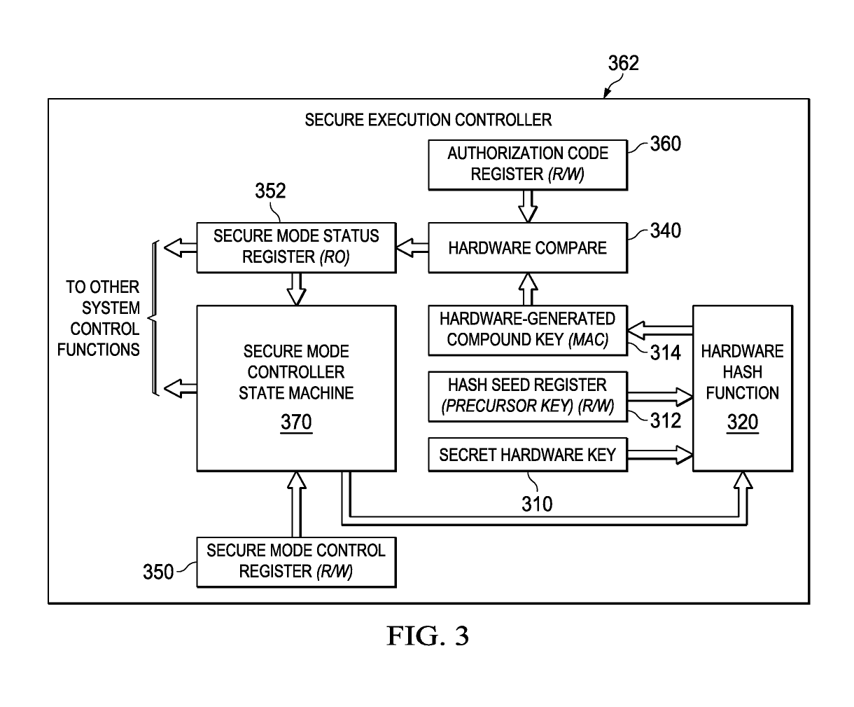

Referring to FIG. 3, one embodiment of the architecture of a secure execution controller is depicted. In this embodiment, secure execution controller 362 is associated with a CPU of a system in which it is included and is intended to support the execution of a candidate code block in secure mode on the main CPU. As such, secure execution controller 362 may comprise one or more registers, including a secret hardware key 310 which is not visible to the CPU, secure mode control register 350, authorization code register 360, secure mode status register 352, hash seed register 312 and hardware generated compound key register 314. Of these registers, all but secret hardware key 310 may potentially be readable by a CPU without affecting the overall security of the system, although any of these other registers may or may not be visible to processes other than the one currently executing (either in secure mode or not). In particular, if the hardware generated compound key register 314 is readable by the CPU, it should only be readable in the context of a particular secure process that is used to validate the authorization of another (distinct) secure process—and only for that (authorization) purpose.

Secure mode control register 350 may be a register that may be written to in order to attempt to place the target device in a secure mode. The secure mode control register 350 may have a register into which a memory location (e.g., in an I-cache or main memory) corresponding to the beginning address of a candidate code block (e.g., a code block to be executed in secured mode) may be written and a separate register into which the length of such a candidate code block may be written. Authorization code register 360 may be a location into which an authorization code or another type of key or data may be written. Secure mode status register 352 may be a memory-mapped location comprising one or more bits that may only be set by hardware comparison block 340 and which can indicate whether or not the target device 100 is operating in secure mode.

Hardware hash function block 320 may be operable for implementing a hash function substantially in hardware to generate a compound key 314. Hardware hash function block 320 may, for example, implement a SHA 256 or some similar one-way hash function. However, this hash function may also be implemented in software or in firmware running on either a separate processor from the CPU of the system, or even a process that is run on the CPU in secure mode, using a virtual hardware hash function methodology as described earlier.

Hardware hash function block 320 may take as input one or more of the values stored in the hash seed register 312, secret hardware key 310 or data from another location, concatenate these inputs (e.g., prepend or append one input to another) and hash the resulting data set to generate a message authentication code, which we have referred to earlier as a one-way compound key.

In certain embodiments, almost any numeric value can be provided as an input (precursor) for hardware hash function block 320. For example, the input data for the hardware hash function may be constructed by a concatenation of the secret hardware key, a hash seed precursor key and a secure code block candidate. There may be no fundamental difference in the operation of the hash function, almost no matter what the input data represent or how large any of these data sets may be. It should also be noted that there may be other inputs to the hardware hash function coming from a secure mode controller state machine that function as control inputs as opposed to input data to the hash function.

Hardware generated compound key register 314 is configured to store the output of the hardware hash function block 320. Hardware comparison block 340 may be configured to compare the data in hardware generated compound key register 314 with the data in authorization code register 360. If the two values are identical the hardware comparison block 340 is configured to set the one or more bits in secure mode status register 352 that place the target device in secure mode. As mentioned earlier, in the case where the hash function 320 is implemented in secure software, then the output of that hash function software (effectively a digital signature or message authentication code) may be stored in this compound key register 314. In that case, the CPU may clearly be able to access the value of this register (since it created the value in the first place). However, the only process that should be able to access the value stored in this register should be the secure process that is used to implement the hash function 320 and the subsequent comparison function 340 (which may itself be implemented hardware or in secure software).

Secure mode controller state machine 370 may be logic (e.g., hardware, software or some combination) that may operate based on the state of bits of secure mode control register 350 or secure mode status register 352. Secure mode controller state machine 370 is configured for controlling inputs to hardware hash function block 320, such that the precursors may be utilized in the correct manner to generate the desired output 314 of hardware hash function block 320. For example, secure mode controller state machine 370 may be configured to cause the resulting output to be loaded into hardware generated compound key register 314 at the proper time. Additionally, secure mode controller state machine 370 may be configured to cause the correct data to be written to secure mode status register 352.

Secure mode controller state machine 370 may also be configured for controlling memory access when the target device is executing in secure mode. In one embodiment, when the bits in secure mode status register 352 that indicate that the target device is now operating in secure mode, then secure mode controller state machine 370 may be configured to determine which of the pages of the data cache have been assigned to that process and store a secure descriptor for that process in the data cache in association with the one or more of the pages of the data cache. These secure process descriptors may thus be used to associate a particular set of data that is being stored in the data cache with a specific process that is executing in secured mode. Such a secure process descriptor may, for example, be the value that is based on the data that is located in authorization code register 360 or the hardware-generated compound key register 314.

Additionally, when the bits in secure mode status register 352 that place the target device in secure mode are set, secure mode controller state machine 370 may be able to selectively enable or disable memory accesses by the process executing in secure mode and determine if the memory access is a read or a write access.

If the data access consists of a write operation, the secure mode controller state machine 370 may be configured to determine the cache line of the data cache corresponding to the address where the data is to be written and then set a security flag associated with that cache line to indicate that the data contained in that cache line is secure. In certain embodiments, secure mode controller state machine 370 is also configured to prevent any writes to any memory location which is not in the data cache, for example by disabling write-through, write-back or other operations of the data cache or memory controllers of the target device.

If the access is a read access the secure mode controller state machine 370 may be configured to determine if a cache miss has occurred and if the requested address was not previously stored in the data cache the secure mode controller state machine 370 may be configured to allow the requested data to be read from main memory and placed in the data cache in a page associated with the process. If a cache hit occurs the secure mode controller state machine 370 may be configured to the determine the cache line corresponding to the address of the memory access and check the security flag associated with that cache line to determine if it is set. If the security flag is not set the memory access may be allowed to proceed (e.g., the data read from the cache line).

Alternatively, if a security flag associated with the cache line in the data cache corresponding to the address from which data is to be read is set, secure mode controller state machine 370 may be configured to obtain the secure process descriptor associated with the page in the data cache containing that cache line and compare it with a secure process descriptor associated with the currently executing. If the secure process descriptors match, then the memory access may be allowed to proceed. If the secure descriptors do not match, another action may be taken such as either returning a garbage or preset value in response to the memory access or alternately returning a “no-valid data” at that address message to the CPU, whereupon the CPU memory management unit may then request a replacement cache line to read in from system memory.

In one embodiment, only the data cache is used to store the entire working set of a process executing in secure mode and any writes to memory other than to the data cache by the process may be disabled. Additionally, any lines of the data cache that are written to (e.g., so-called “dirty” cache lines) while in secure mode are associated with a secure process descriptor that may uniquely and precisely specify which process to whom the “dirty” cache line belongs. Access to these cache lines may only be allowed to the owner of the particular “dirty” cache line such that any cache line modified during the operation of a secure process is unreadable by any other process, even after the original process has terminated. Thus, data that belongs to one instance of a process is unambiguously isolated from any other process.

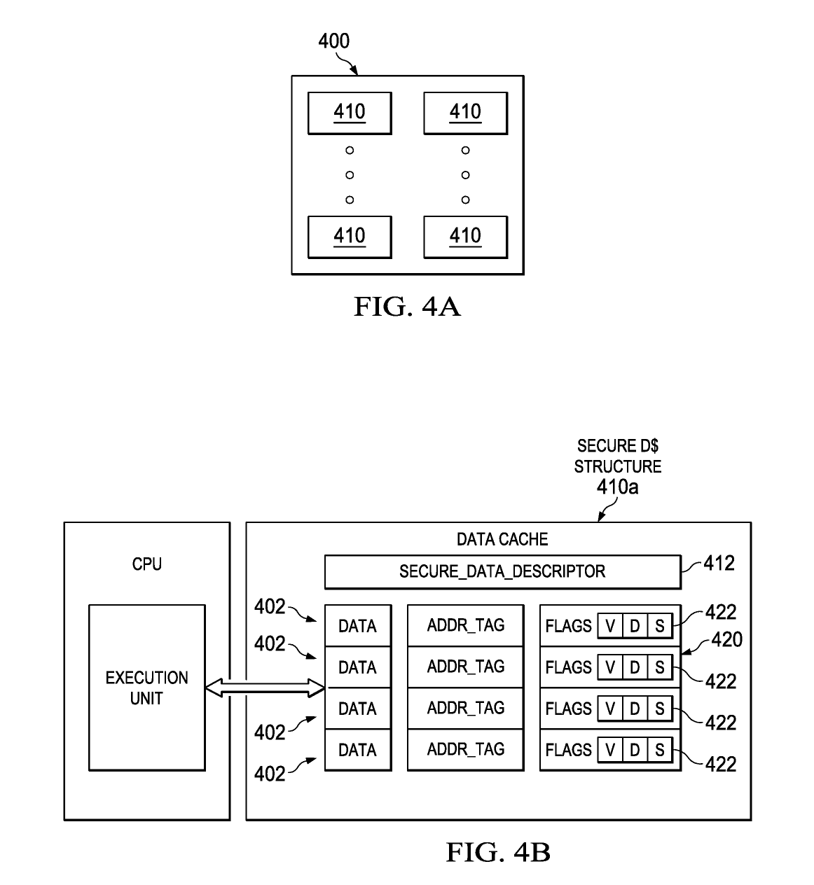

It may also be helpful to give a general overview of an exemplary data cache architecture. FIGS. 4A and 4B illustrate one embodiment of the architecture of a data cache that may be utilized to effectuate isolation of working sets of processes according to certain embodiments. Referring first to FIG. 4A, data cache 400 may be almost any type of cache, including a L1 cache a L2 cache, a direct mapped cache, a 2-way set associative cache, a 4-way set associative, a 2-way skewed associative cache, etc. that may be implemented in conjunction with almost any management or write policies desired. The cache 400 may comprise a set of pages 410. When used when referring to the cache herein, a page may be understood to mean cache block or a cache set. The data cache 400 is configured to store a secure descriptor associated with one or more pages 410 of the cache.

FIG. 4B depicts a view of one embodiment of a page 410a of cache 400. Here, the cache comprises logic 412 designed to store a secure process descriptor in association with the page 410a and to provide the secure process descriptor in response to a request for the secure process descriptor for page 410a or in conjunction with a read to a cache line 402 of page 410a. Each cache line 402 of the page 410a includes bits for the data, address tags and flags 420. The flags 420 may include bits such as a valid bit or dirty bit. In addition, flags 420 may include a secure bit 422. Cache 400 may be configured such that a secure bit 422 for a cache line 402 may be set (e.g., when a process executing in secure mode writes to that cache line 402).

It will now be useful to explain how embodiments of such a target device may be place in secured mode. It should be noted that, in one embodiment, the procedure by which any generic (or otherwise) block of code (which will be referred to as a “secure work function”) may be executed in secure mode on embodiments of a system such as those described herein is to execute a pair of extra functions, one on either side (e.g., before or after) of the secure work function. A function (or set of functions) that is executed immediately prior to a secure work function will be referred to as the “prologue” and a function (or set of functions) which is executed immediately after the secure work function will be referred to as the “epilogue”.

Thus, in one embodiment, in order to execute a secure work function on a CPU, then that secure work function should be preceded by a prologue and followed by an epilogue. In certain embodiments, the purpose of the prologue is at least threefold. First, the prologue should prepare the input arguments that are passed to the secure work function for use by the secure work function. This preparation may involve, for example, a decryption process, which may be required for those input arguments that may not be passed to the secure work function in the clear. A second function of the prologue may be to construct a compound key or digital signature whose value is dependent on a number of data elements. Such data elements may include the hardware secret key of the target device, the Authorization Code of the parent (e.g., calling) function, a list of one or more input arguments to the secure work function (either in encrypted or non-encrypted form), the executable image of the secure work function itself, or some other information that may be used in determining whether or not the secure work function should be allowed to execute on the target device in secure mode. A third function of the prologue could be to create a nonce (e.g., a non-repeating value) at the time of the initial a request that the CPU begin executing the secure work function in secure mode.

The purpose of the epilogue may be to “clean up” after the execution of the secure work function is complete. One function the epilogue may be to prepare any designated output parameters for use by subsequent code blocks (e.g., to be executed after the secure work function), be they secure or not. For example, this preparation may involve encrypting of the designated output (or returned data) from the secure work function so that any observing process other than the intended recipient of such output arguments, including either hardware or software-based observers, may be precluded from effectively intercepting that data. In such a case, the encryption key that may be used may be a compound key that is based on the public data that are passed to the secure routine as part of its calling arguments.

A second function of the epilogue may be to either programmatically or automatically invalidate those portions of a data cache that have been written to while the secure work function (e.g., by the secure work function) was executing. Thus, in the case where a secure work function may have had its operation suspended and then resumed, the data values that were written to a secure portion of the data cache prior to the process being suspended may thus be available to the resumed secure process without having to page these secure data locations out to memory (which may involve an intervening encryption and subsequent decryption process). Then, once the secure function had been resumed, these same data cache locations may then be made available to the secure function, since the secure process descriptor may match the currently executing authorization code, or some derivative thereof (or another value being used as a secure process descriptor).

However, once a secure process had terminated (for example, using an epilogue function), then these same secure data cache locations may be marked as invalid during the epilogue function. This invalidation process would prevent any unintended potential “leakage” of data that may still be resident in the secure portion of the data cache, keeping them from being accessed after the secure work function has terminated properly.

In this manner, even if a secure work function is repeated and if it is given the same secure process descriptor twice in a row, the second iteration of this secure work function will nonetheless be unable to access the working set data from the first iteration of that same secure work function, despite the fact that they might have the same secure process descriptor for both iterations. One simple means by which this desired functionality may be accomplished is by using the nonce mentioned earlier, where the nonce is only created and stored at the time that the secure function is initially called. Then, if the function is resumed after a suspension, then nonce may not be updated, meaning that the resumed secure function will be able to access the interrupted working set data. However, this mechanism opens up the possibility of a replay attack on a suspended but not terminated process. One simple manner to counter this potential attack would be to keep a separate “secure process status” table in the Secure Mode controller block (which may itself be implemented in hardware or in secure software). If an associated secure process status record indicates that it is suspended, then it may potentially not be allowed to resume more than once with the same nonce. There are, of course, numerous similar means by which this same functionality may be accomplished and it will be noted that the descriptions of the prologue and epilogue are provided by way of example and that more or fewer functions may be accomplished by the prologue of the epilogue and that additionally, these function (or additional or fewer function) may be accomplished in another manner without departing from the scope of embodiments as described.

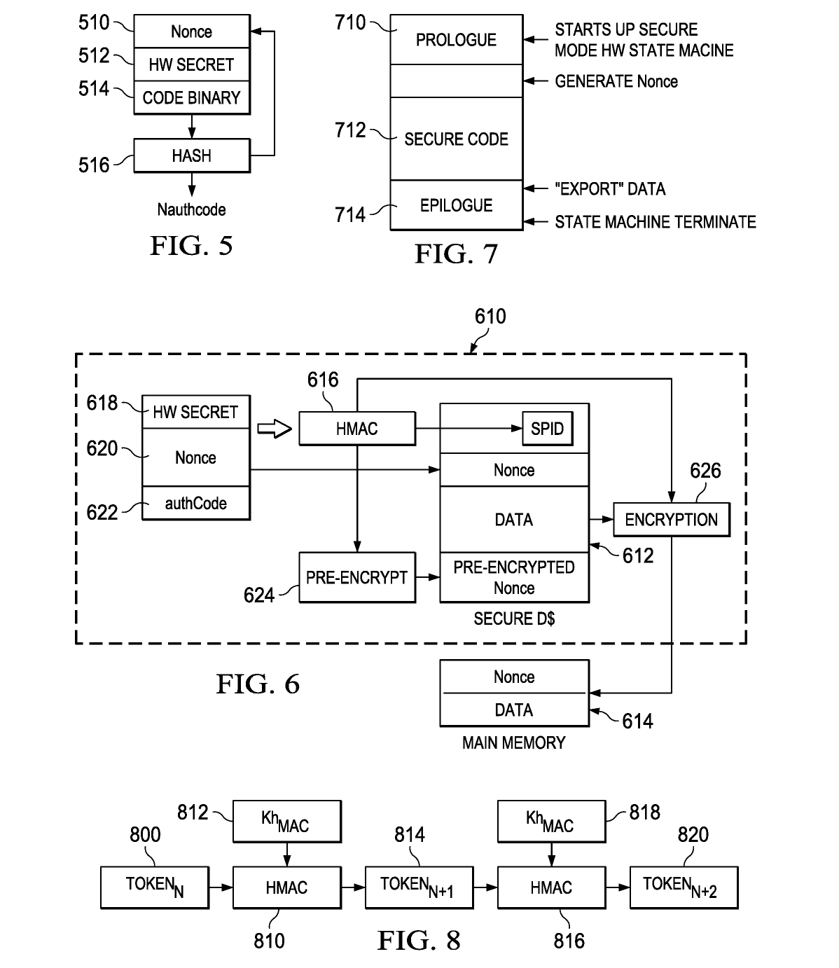

As stated above, if the secure process' authCode and a nonce (plus the processor's hardware secret key) are used as precursors to a compound encryption key, then this encryption key can be recreated at will using just the (public) precursors. This mechanism can be used by a secure process to safely page its secure data out to main memory. An example of this is illustrated more particularly in FIG. 5. FIG. 5 is a block diagram depicting a nonce-based authCode/encryption key generated in hardware. A nonce 510 and the hardware secret 512 are used in conjunction with the cached code 514 to be protected, and fed into a hash function 516. The hash function 516 generates a unique NauthCode which can be used as an encryption key for securely paging cache data out to main memory. Since the nonce changes every time, the nonce based authCode NauthCode also changes every time. In some embodiments, the nonce may be generated from the previous operation's NauthCode fed back into the hash function input.

However, one complication can arise if the method used to generate the nonce is itself secure. This is desirable, since one method to attack this compound key generation mechanism is to maliciously manipulate the value of the nonce (which is public). Thus, the nonce should be generated securely; either by a software-based method (a process running in secure mode, such as in the “Prologue” section just preceding the Secure Code block as shown in FIG. 7) or a hardware-based mechanism (one which may need to use the processor's hardware secret, e.g., by the feedback line shown in FIG. 5). In this case, the nonce itself would then be considered as “secure” data and would thus not be able to be stored in the clear in main memory.

This situation is interesting, since the nonce itself could be encrypted prior to being paged out to main memory, but the compound key for that encryption process would have to be somehow accessible, which would lead to yet another nonce, etc. However, this seemingly classic “chicken and egg” problem can be solved. Recall that the secure process (the one that must create the compound encryption key) is actually the “owner” of both the (securely generated) nonce as well as the resultant compound encryption key. Thus, the secure process can simply “pre-encrypt” the nonce with the (known) compound encryption key and then store it back in place (in the secure data cache). Then, when the secure process overflows and the cache line containing the nonce is paged out to main memory, it will be “re-encrypted” (e.g., decrypted) with the very same compound key that was used to “pre-encrypt” it in the first place. Thus, when the nonce is written out to main memory, it will actually be stored in the clear, without ever having to expose the value of the encryption key to any outside observer.

This is illustrated more particularly in FIG. 6. FIG. 6 illustrates a secure process dataflow. A secure processor 610 implements a secure data cache (D$) 612. When the data stored in the data cache 612 are paged out from the secure cache 612 into main memory 614, they are encrypted using an encryption key generated using a keyed one way hash (or HMAC) 616, as discussed above, based on the nonce 620, the hardware secret key 618, and the secure processor's authCode 622.

The nonce itself is stored in the secure D$ 612 and pre-encrypted using the generated encryption key (via pre-encryption block 624) before being stored back in the secure D$ 612. When data in the secure D$ 612 are paged out to the main memory 614, the data, along with the pre-encrypted nonce, are first encrypted using the encryption key (via encryption block 626). This decrypts the nonce, and it is stored in the clear in main memory 614 and can be available when reading data back in.

FIG. 7 illustrates one example of a secure software implementation. In the example of FIG. 7, a secure software implementation includes a prologue 710. The prologue 710 informs the secure mode hardware state machine where and how big the candidate secure code block is. Once it has been verified, the secure code 712 generates a new nonce (the first part of the secure code) in the prologue 710 and then, in an epilogue 714, data are exported (after being pre-encrypted, as described above) securely to main memory and the state machine is shut down.

The mechanism described above can potentially be subverted by an external attack based on use of the data that has been paged out to main memory. This could be accomplished if either the encrypted data is maliciously modified or if the nonce value itself is modified. For example, one might envision a “replay attack”, where a nonce from a previous invocation of a particular secure process is inserted into the data set in place of the correct nonce. In this replay attack scenario, one or more of the mechanisms mentioned earlier can be used to counter the replay attack. The basic requirement for replay-attack prevention is that there must be some “independent” reference that can be used to store the current condition or some derivative of the current condition of a secure process. That independent reference can be local (e.g., contained within the Secure Mode Controller) or it can be remote (e.g., at the service). In either case, there are numerous equivalent methods by which the reference can be evaluated in the secure process suspend/resume mechanism, all of which are contemplated herein.

In any case, any data corruption problems can be detected by “signing” the encrypted data set that is paged out to main memory (e.g., with a Message Authentication Code—or MAC). As before, such a MAC can be created by passing the encrypted data that is to be paged-out (including the unencrypted nonce) through a one-way hash function, along with the same secret value that was used in order to create the encryption key described above. Thus, if the paged-out data had been corrupted by an external party while it was in main memory, then that corruption would be detectable when the data was subsequently read back into the secure data cache prior to decryption. Since the secret value is not accessible to the CPU (i.e., it is architecturally invisible), then there is no way that any process (secure or not) can correctly recreate the value of the resulting MAC if any of the paged-out data has been modified. Of course, this mechanism cannot protect a secure process from a denial-of-service style attack (i.e., if the encrypted paged-out data set is modified or deleted), unless some other method is used (for example, a multiply redundant backing store).

The techniques described above are also useful for multi-threaded secure operations. In the case where a secure process is interrupted by some other process, then all of its intermediate data may be paged out to main memory using this same mechanism, whereupon it can then be re-created back in the secure D$ in the clear when the secure process is resumed by reversing the encryption procedure described above. Essentially, as described above, this mechanism can be used to automatically decrypt the data as it is read back into the data cache from main memory without the processor having any “knowledge” of the architecturally invisible secret or even of the compound encryption key, outside of the secure process to which this compound key belongs. If the system is designed according to the structure that was described in U.S. Pat. No. 7,203,844, then there is no way that the processor can correctly decrypt the paged-out data, even if the nonce input value is known, without using this hardware-based “automatic” decryption mechanism.

Finally, in a system where every time a datum is written to by a processor executing in secure mode, then it is automatically included in this “secured data block”, then there is no way for an external process, either secure or not, to interact (correctly) with this secured data. As stated earlier, if the input to this digital signature mechanism is nonce-based, then even an exact duplicate of the interrupted secure code block cannot access the data created by a distinct copy of itself, since the resulting encryption keys will be different; due to each distinct process having a different input nonce value. Thus, the security of such a system depends simply on the security of the nonce generation process, which as stated earlier, can be accomplished either in secure mode software or by a hardware-based mechanism.

Let us now consider the event where a secure process is interrupted mid-execution and its working data set is paged out of secure D$ and then execution is resumed at some later time. First, from a perspective of increased security (and to some extent, simplicity), it should be clear that the process would not “reacquire” the old (paged-out) nonce value when it resumes secure execution. At the very least, that kind of mechanism (where the old nonce value was reinstated) would open up a large vulnerability window for replay-style attacks. Thus, when the secure process resumes, it will actually have a new nonce. So any newly updated data would then subsequently be paged out to memory using a different encryption key.

Thus, to read back in data that had been paged out while executing a previous incarnation of the process, the system would need the older value of the nonce in order to read that data back into the secure D$, but once that data had been safely restored into the secure D$, the old nonce value would no longer be needed. This makes it simple to understand which nonce should be used as the precursor of any compound key (or any digital signature-based derivative thereof) for any subsequent re-encryption operations (on a subsequent page-out, for example). Since that restored data would have originated as “secure” data (or else it would not have been paged out in encrypted form in the first place), then when that “old” data is restored into the secure D$, it must be marked as “secure” (i.e., the “S” bit must be set in the secure D$ line flags field).

This way, if any such data were to be paged out again, it would presumably be re-encrypted; but this time, using the new value of the nonce-derived compound key as the encryption key. However, if this encrypted page-out process were to be used on unmodified data, then this would constitute another potential attack vector. This attack would be based on the fact that multiple encryptions of the same data with different keys would allow the attacker to accumulate statistical data on the ciphertext and thus, would help them to guess the original plaintext. Fortunately, this potential problem can be resolved simply by not setting the secure D$ “dirty” bit when the “old” data is read in from main memory (and decrypted) and restored back into the secure D$. Then, unless the processor writes the same value to this location over and over during separate execution instantiations, this data would never get written back out to main memory encrypted with a different NauthCode value.

However, by itself, this mechanism will potentially allow subsequent instantiations of a secure process to read back in data that was used in a prior instantiation and thus, potentially compromise the system by reading in partial results from previous instantiations and then further operating on these “older” data results. Thus, embodiments may include methods that will prevent this style of attack.

As mentioned earlier, one exemplary mechanism for providing privacy of data and preventing replay attacks involves a “local” independent reference point for maintaining the secure process status information. We can refer to such a local reference point as a “mini service”. In some cases, this “mini service” can be implemented as an independent secure-code based (virtual hardware) device, using the same hardware root of trust as the (also virtual) device being managed, but with an independent device secret. This local “mini-service” operates in the same manner as an external service, in that it can issue authorization codes for the managed virtual device and issues Kh next precursors for the managed virtual device. The local mini service may itself be managed by a (non-virtual) external service, and it may use local (internal) entropy, or that entropy may be supplied by a second external service. In both cases, the (non-virtual) external service is aware that it is talking to a secure device, but is not necessarily aware that it is talking to a virtual secure device.

As mentioned above, one potential problem with relying on input from a third party, for example, an external service or central licensing authority (CLA), is that if the CLA is compromised or untrusted, then the device's (ostensibly private) data can be compromised. One solution to this problem is for a device to create an encryption key that requires information from two (or more) independent sources. In one example, a device creates an encryption key based on information from (1) a CLA and (2) an internal entropy source. Since the resulting encryption key is derived from information from the CLA and the internal entropy (which cannot be predicted), the encryption key (even if the CLA is compromised) will not be compromised. In some examples, internal entropy is not available, or is not reliable. In a second example, a device creates an encryption key based on information from (1) a first CLA and (2) a second CLA. Since the resulting encryption key is derived from information from both the first CLA and the second CLA, the encryption key (even if either CLA is compromised) will not be compromised.

FIG. 8 is a block diagram illustrating a basic principal of creating a multi-part token that is derived from two different device secrets. The multi-part token may then be used as an input to an encryption key derivation function (KDF). As shown in FIG. 8, a Token_{N} input 800 (public data, provided by an external service, for example) is provided as an input to a keyed one way (hardware) hash (HMAC 810) using one device secret Kh_{MAC} 812 (which itself may be a derived value from the device's architecturally invisible secret) that is used as the key for the HMAC hashing function. The result, Token_{N+1} 814 can only be derived if Kh_{MAC} 812 is known. In a second iteration, this result (Token_{N+1} 814) is provided as an input to a second keyed one way (hardware) hash (HMAC 816) using an independent Kh_{MAC} 818 (device secret) as the key input to the HMAC hashing function. The result of that second HMAC operation (Token_{N+2} 820) can only be derived if Token_{N+1} 814 and device secret Kh_{MAC} 818 are both known. The reverse transform is highly difficult, even if either one (but not both) of the values for Kh_{MAC} (812 or 818) is known.

If this resulting second-stage token 820 is then used either in the creation of as the key for a secure encryption operation, then an entity that knows either value for Kh_{MAC} (812 or 818) but not both will not be able to decrypt the resulting data. Thus, we have created a mechanism for encrypting data such that two independent parties must cooperate in order to encrypt or decrypt data but neither of the two parties may unilaterally do so successfully. However, this mechanism does have weakness in that the first entity (e.g., an external service) may have to trust the other entity not to archive a copy of the intermediate token (814). This deficiency may be remedied with a modification to the mechanism as discussed at other points herein.

In this manner, any encryption keys that are generated as a part of this process can be based on information from a service and a local (internal) entropy source or from information provided by two independent services. In any case, neither of the services (the two independent external services or the external service and the internal “mini service”) have enough information by themselves to be able to unilaterally regenerate the derived encryption keys. Using this mechanism, the only way that the actual encryption keys may be recreated is if the two independent services exchange information with each other. If the device has a local (internal) source of entropy designed into the hardware that is designed to be hidden from external observation, then there is no way for the external service to recreate the derived encryption keys unless the device's hardware is somehow compromised. The remote service could be implemented using another secure target device of similar design, or it could be a device with a completely different design using a completely different security mechanism. Note that, with respect to secure data cache eviction and restoration, the encryption key may have to be generated twice, once on data eviction and once on data restoration.

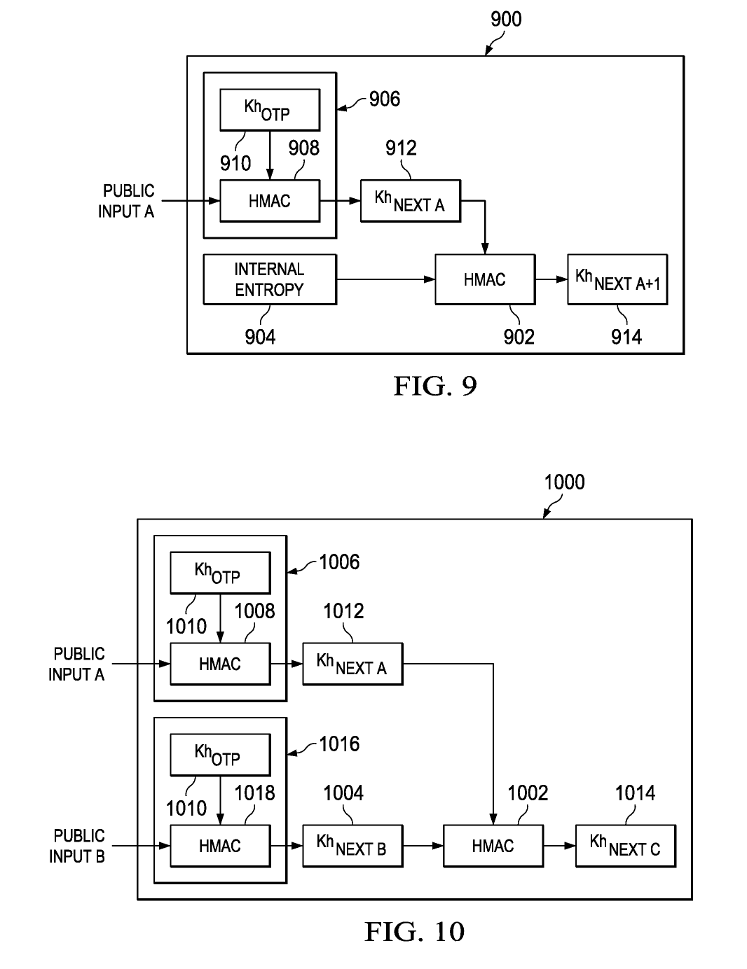

FIG. 9 is a block diagram illustrating an example where an encryption key is generated based on information from a CLA and an internal entropy source. FIG. 9 shows a device 900 comprising a pair of hardware-based or secure software-based (e.g., a virtual equivalent of a hardware-based) HMAC function blocks 902 and 908 and an internal entropy source 904. As discussed earlier, either of the HMAC function blocks may be implemented using hardware or virtual equivalents thereof. Here, the entire functional block 906 may be implemented as a virtual machine using a software based HMAC 908 keyed using device secret Kh_{OTP} 910. The resulting output of the virtual machine 906 is then used as the device secret 912 for the subsequent HMAC function 902.

In this example, HMAC 908 receives PUBLIC INPUT A (for example, from a CLA) and uses it (along with its own device secret 910) to create an intermediate output Kh_{NEXT A} 912. Note that the CLA can presumably recreate output Kh_{NEXT A} 912, knowing PUBLIC INPUT A and Kh_{OTP} 910. At a second iteration, Kh_{NEXT A} 912 is used as the key to HMAC 902 to generate a subsequent HMAC output Kh_{NEXT A+1} 914 using internal entropy 904, resulting in an output Kh_{NEXT A+1} 914 that cannot be recreated by any external entity (e.g., an entity that does not have visibility of the internal entropy value 904). The device 900 can then use Kh_{NEXT A}+₁ 914 or a further derivative thereof as an encryption key to conceal data from any such external entity. Since a compromised CLA cannot know the value of the internal entropy, the CLA cannot determine Kh_{NEXT A+1} 914, and thus, data encrypted using Kh_{NEXT A+1} 914 as an encryption key will be secure.

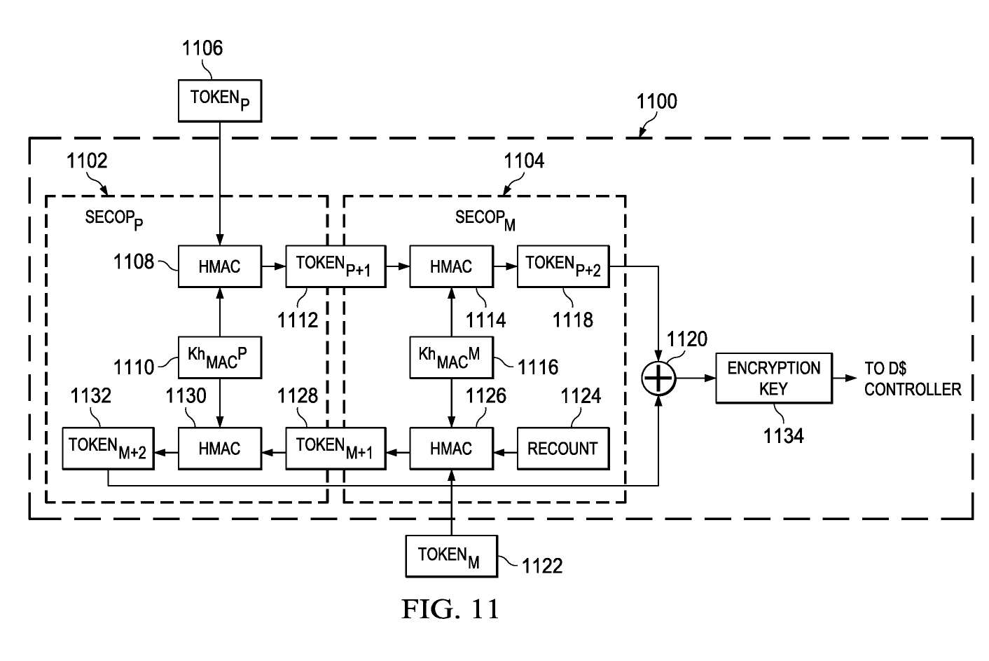

FIG. 10 is a block diagram illustrating an example where an encryption key is generated based on information from two independent CLAs. FIG. 10 shows a device 1000 having a hardware based HMAC 1002. The device 1000 also includes a pair of virtual machines 1006 and 1016. Both virtual machines 1006 and 1016 comprise a software based HMAC 1008 and 1018 keyed using the same device secret Kh_{OTP} 1010. In this example, HMAC 1008 receives PUBLIC INPUT A (for example, from a first service (or CLA) and passes it through the HMAC function 1008, resulting in intermediate output Kh_{NEXT A} 1012. Note that the first CLA can presumably recreate output Kh_{NEXT A} 1012, knowing PUBLIC INPUT A and Kh_{OTP} 1010. However, if the first service does not know the value of Kh_{OTP} 1010, then it can still know the value of Kh_{NEXT A} 1012, if that value has been previously shared with the first service by some other means. One method by which this Kh_{NEXT A} 1012 value may be shared securely with the first service is described in U.S. patent application Ser. No. 15/227,421, entitled “System and Method for Initializing a Shared Secret System”, by Oxford et al., filed on Aug. 3, 2016, and fully incorporated herein by reference in its entirety, but there are a number of different mechanisms by which this value may be synchronized with the firs service.

Similarly, a second service may provide a different PUBLIC INPUT B value to the second virtual machine 1016. In this case, virtual machine passes this PUBLIC INPUT B value through the HMAC function 1018, resulting in intermediate output Kh_{NEXT B} 1004. As above, this Kh_{NEXT B} value 1004 may be able to be recreated by the second service if that service knows the value of Kh_{OTP} 1010. However, if Kh_{OTP} 1010 is not known by the second service, then the resulting output of HMAC 1018 (Kh_{NEXT B} 1004) may still be known by the second service if that value has been explicitly shared with that service previously.

Next, the calculated value Kh_{NEXT B} 1004 is run through the HMAC function 1002 using the value Kh_{NEXT A} 1012 as the key to HMAC function 1002 to create the resulting value Kh_{NEXT C} 1014. This value Kh_{NEXT C} 1014 cannot be calculated by either service if neither of them share their respective secrets (Kh_{NEXT A} 1012 for the first service or Kh_{NEXT B} 1004 for the second service) with each other. Additionally, even if the value of Kh_{NEXT C} 1014 is somehow exposed or leaked, then the knowledge of Kh_{NEXT C} 1014 will not compromise either of the precursor secrets Kh_{NEXT A} 1012 or Kh_{NEXT B} 1004. Thus, in this case, the value of Kh_{NEXT B} 1004 acts in a manner that is analogous to that of the internal entropy 904 from the mechanism illustrated in FIG. 9. Since either of the two services in this mechanism may be situated entirely inside the device 1000 (as long as that service comprises a means for generating its own independent entropy), then we can thus see how these two mechanisms illustrated in FIG. 9 and FIG. 10. are equivalent in functionality.

FIG. 11 depicts an embodiment of a device 1100 that utilizes at least two distinct “virtual machines” (1102 and 1104) to create an encryption key that is generated based on information from both of the two independent virtual machine “domains”. In practice, there may be more than two virtual machine domains used to create the final encryption key, but there should be at least two in order to maintain the desired security properties.

The mechanism shown in FIG. 11 can employ the method described in FIG. 10 to create two independent HMAC keys, which may be derived from a single fixed internal entropy value and a corresponding pair of individually-shared derivative values or it may be accomplished by means of an external entropy source and an internal entropy source (where the internal entropy source is not visible to external parties) to “anchor” the two distinct “virtual machines” (1102 and 1104). In this manner, the final resulting encryption key 1134 can be created in such a manner that any data encrypted with this key 1134 is secure from external discovery (including any services or CLAs that operate to manage the device 1100), whether or not there is an internal source of entropy on the device 1100.

As shown if FIG. 11, the device 1100 receives TOKEN 1106 (for example, public data from a first CLA P) and transforms it into TOKEN_{P+1} 1112 using HMAC 1108. The key for HMAC 1108 is Kh_{MAC}P 1110, which is secret data, accessible by first CLA P and usable inside the boundary of SECOP_{P} 1102, but not by the second CLA M and not accessible by the device when it is executing inside the SECOP_{M} 1104 boundary. The output of HMAC 1108 (TOKEN_{P+1} 1112) can be recreated by service or CLA P as long as TOKEN 1106 and Kh_{MAC}P 1110 are known to it.

TOKEN_{P+1} 1112 (private data created inside of SECOP_{P} 1102) is passed on to SECOP_{M} 1104 and subsequently transformed into TOKEN_{P+2} 1118 using HMAC 1114. The key for HMAC 1114 operation is Kh_{MAC}M 1116, which is secret data, known only by second CLA M and accessible only by SECOP_{M}1004, but not by the first service CLA P or by the device unless it is operating inside the SECOP_{M} 1104 boundary. As before, the output of HMAC 1114 (TOKEN_{P+2} 1118) can be recreated as long as TOKEN_{P+1} 1112 and Kh_{MAC}M 1116 are known, but since the TOKEN_{P+1} 1112 datum is only made available to the device while it is operating inside the SECOP_{M} 1104 boundary, then the service CLA P has no way of knowing the TOKEN_{P+1} 1112 value.

In a similar manner, FIG. 11 also shows that device 1100 receives TOKEN_{M} 1122 (for example, public data from second CLA M). TOKEN_{M} 1122 is combined with Recount 1124 (as explained in more detail below) and transformed into TOKEN_{M+1} 1128 using HMAC 1126, which uses the value of Kh_{MAC}M 1116 as its key input. As mentioned above, the key Kh_{MAC}M 1116 is secret data and is known only by second CLA M and may only be used inside the boundary of SECOP_{M} 1104. Thus, it is not known by the second CLA M and may not be used outside of the SECOP_{M} 1104 boundary. The output of HMAC 1126 (TOKEN_{M+1} 1128) can be recreated as long as TOKEN_{M} 1122 and Kh_{MAC}M 1116 are known. Subsequently, the TOKEN_{M+1} 1128 value is passed into the SECOP_{P} 1102 domain and there, it is subsequently transformed into TOKEN_{M+2} 1132 using HMAC 1130.

Finally, both resulting tokens (TOKEN_{P+2} 1118 and TOKEN_{M+2} 1132) are then combined using XOR 1120 in order to produce the ultimate encryption key 1134. It is evident that the generation of encryption key 1134 requires information from both CLA P and CLA M, and cannot be independently generated by either CLA. Furthermore, if either service CLA P or service CLA M decline to participate in the key generation process (by means of refusing to authorize the operation of their dependent SECOP, then the other service cannot unilaterally create (or recreate) the final encryption key 1134.

If the encryption key 1134 is used by the device's data cache controller to encrypt data that is paged out from secure data cache into shared memory, then only be the cooperation of both services CLA M and CLA P may this data ever be correctly recovered. Therefore, even if one CLA is compromised or untrusted, the compromised CLA cannot unilaterally generate encryption key 1134.

In the example described above with respect to FIG. 11, the same encryption key can be created over again, but neither service (CLA P or CLA M) know what the key is, and have no way of computing the key. In examples where data is encrypted and moved off-chip, then power down and power back up, the same encryption key can be recreated, since the inputs are public. However, sometimes it may be desired to get a different result (a different encryption key) to prevent replay attacks.

The example shown in FIG. 11 provides replay attack protection by using an internal counter (referred to as the “RECOUNT” register 1124) that is maintained by one or the other of the device's virtual machine “domains”. It is not critical to the security of the system if the value of this RECOUNT register is made public, but it embodiments it must not be able to be modified by an external attacker. If there are more than two distinct virtual machine domains in a given embodiment, then there need only be one such “RECOUNT” register in the overall system. In any case, this “RECOUNT” register 1124 may be utilized by prepending the value of the register to the externally supplied (token) input to the HMAC function (TOKEN_{M} 1122 in the example shown in FIG. 11) prior to evaluating the HMAC function (1126 in this example) and thus generating the resulting output TOKEN_{M+1} 1128. It should be noted in this case that the order of the input to HMAC 1126 (i.e., the exact ordering of the RECOUNT 1124 and TOKEN_{M} 1122 values), while not exactly the same, is not critical to the security of the system. Clearly, the resulting output TOKEN_{M+1} 1128 will be different between the two implementations, but the differences between the two options are not vastly different from a security standpoint. Thus, either option (i.e., HMAC 1126 input={RECOUNT 1124, TOKEN_{M} 1122} or HMAC 1126 input={TOKEN_{M} 1122, RECOUNT 1124}) can be considered to be functionally equivalent in this case.

In many cases, the internal count register may simply be a non-repeating random number or nonce. In some examples, though, it is desired to recreate the encryption key once, for example to decrypt data that was temporarily moved off-chip.

There are several ways to allow the encryption key to be recreated once. In a first example, the internal count register is only incremented after a second data transfer (e.g., the first is to encrypt, the second is to decrypt). In another example, the lower bit is masked, so the count will increment twice before Recount 1124 changes value. Ideally, the internal count register is formed in chip persistent memory, so the counter value persists after a power down. Other ways are also possible.

Note that, in some examples, replay attack prevention uses at least two parties (one “local”, one “reference”). Also, in some examples, both parties must participate in the process, and neither party can complete the operation unilaterally. In some examples, tokens are only used once (per eviction/restoration operation). In examples using the internal count register (Recount 1124 in FIG. 11), the recount value is updated after a restore operation. After the recount value is updated, TOKEN_{M+1} 1128 cannot be recreated.

Referring to the methods shown in FIGS. 10-11, the mechanisms described can be extended to include more than two participants. For example, a third CLA can be used with an additional virtual machine, where all devices (physical and virtual) operate together in order to create a final encryption key. In one example, the three could be organized such that the tokens are circulated in a “ring” among the three participants, with the results XOR'ed together to create the final encryption key. In another example, the number of HMAC stages could be limited to two passes (although including at least two in succession), and then all of the “partial” tokens can be XOR'ed together to create the final encryption key. In another example, to the final encryption key can be generated using a subset (e.g., using only two out of three) of the possible virtual machines, which would enable a “voting” scheme where only a majority of the population of virtual machines need to participate, for example.

Although the invention has been described with respect to specific embodiments thereof, these embodiments are merely illustrative, and not restrictive of the invention. The description herein of illustrated embodiments of the invention, including the description in the Summary, is not intended to be exhaustive or to limit the invention to the precise forms disclosed herein (and in particular, the inclusion of any particular embodiment, feature or function within the Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein and throughout the claims that follow, the meaning of “in” includes “in” and “on” unless the context clearly dictates otherwise.

What is claimed is:

1. A method of providing secure operation of a device that is being managed by one or more external services comprising:
the device receiving a first token from a first external service;
the device receiving a second token from a second external service;
generating a first intermediate token derived from the first token and a first key relating to the first external service;
generating a second intermediate token derived from the second token and a second key relating to the second external service;
generating a third intermediate token derived from the first intermediate token and the second key;
generating a fourth intermediate token derived from the second intermediate token and the first key;
combining the third intermediate token and fourth intermediate token to generate a first encryption key; and
using the generated first encryption key to symmetrically encrypt and decrypt data used by the device.

2. The method of claim 1, wherein the data used by the device is encrypted using the generated first encryption key when it is evicted from a secure data cache and subsequently decrypted using the generated first encryption key when it is reloaded into the secure data cache from an external memory.

3. The method of claim 1, further comprising combining a counter with one or both of the first token or second token when generating the first intermediate token or second intermediate token.

4. The method of claim 3, further comprising incrementing the counter to generate a second encryption key after decrypting previously encrypted data.

5. The method of claim 1, wherein one or both of the first token or second token is generated internally on the device using a virtual external service at the device, wherein the virtual external service emulates an external service inside a virtual machine on the device.

6. The method of claim 1, wherein the device receives one or more additional external tokens from one or more additional external services and the one or more additional tokens are used to generate one or more additional intermediate tokens.

7. The method of claim 6, wherein the one or more additional external token are generated internally on the device using a virtual external service at the device, wherein the virtual external service emulates an external service inside a virtual machine on the device.

8. The method of claim 7, wherein the one or more additional external tokens generated on the device are used in the generation of the first encryption key.

9. The method of claim 8, wherein only a subset of the first intermediate token, second intermediate token, third intermediate token, fourth intermediate token or one or more additional intermediate tokens are used in the generation of the first encryption key.

10. The method of claim 9, wherein multiple independent subsets of the first intermediate token, second intermediate token, third intermediate token, fourth intermediate token or one or more additional intermediate tokens are used in the generation of the first encryption key.

11. A device, comprising:
a processor;
a memory;
a secret key stored in hardware;
a secure data cache having a data line comprising data of a process executed on the processor in a secure mode, wherein the device is configured to symmetrically encrypt and decrypt data used by the device using a first encryption key, wherein the first encryption key is generated by:
the device receiving a first token from a first external service;
the device receiving a second token from a second external service;
generating a first intermediate token derived from the first token and a first key relating to the first external service;
generating a second intermediate token derived from the second token and a second key relating to the second external service;
generating a third intermediate token derived from the first intermediate token and the second key;
generating a fourth intermediate token derived from the second intermediate token and the first key;
combining the third intermediate token and fourth intermediate token to generate the first encryption key.

12. The device of claim 11, wherein the data used by the device is encrypted using the generated first encryption key when it is evicted from the secure data cache and subsequently decrypted using the generated first encryption key when it is reloaded into the secure data cache from an external memory.

13. The device of claim 11, further comprising combining a counter with one or both of the first token or second token when generating the first intermediate token or second intermediate token.

14. The device of claim 13, further comprising incrementing the counter to generate a second encryption key after decrypting previously encrypted data.

15. The device of claim 11, wherein one or both of the first token or second token is generated internally on the device using a virtual external service at the device, wherein the virtual external service emulates an external service inside a virtual machine on the device.

16. The device of claim 11, wherein the device receives one or more additional external tokens from one or more additional external services and the one or more additional tokens are used to generate one or more additional intermediate tokens.

17. The device of claim 16, wherein the one or more additional external token are generated internally on the device using a virtual external service at the device, wherein the virtual external service emulates an external service inside a virtual machine on the device.

18. The device of claim 17, wherein the one or more additional external tokens generated on the device are used in the generation of the first encryption key.

19. The device of claim 18, wherein only a subset of the first intermediate token, second intermediate token, third intermediate token, fourth intermediate token or one or more additional intermediate tokens are used in the generation of the first encryption key.

20. The device of claim 19, wherein multiple independent subsets of the first intermediate token, second intermediate token, third intermediate token, fourth intermediate token or one or more additional intermediate tokens are used in the generation of the first encryption key.
